(19) United States
(12) Patent Application Publication
(10) Pub. No.: US 2003/0101772 A1
(43) Pub. Date: Jun. 5, 2003

(54) Manufacturing method for optical fiber preform

(75) Inventors: Sayaka Itoh, Sakura-shi (JP); Masahiro Horikoshi, Sakura-shi (JP)

Correspondence Address: HOFFMANN & BARON, LLP, 6900 JERICHO TURNPIKE, SYOSSET, NY, 11791, US

(73) Assignee: Fujikura Ltd.

(21) Appl. No.: 10/302,049

(22) Filed: Nov. 22, 2002

(30) Foreign Application Priority Data
Nov. 30, 2001 (JP) 2001-367635

(51) Int. Cl. C03B 37/018

(52) U.S. Cl. 65/421

(57) ABSTRACT

An object of this manufacturing method for an optical fiber preform is to provide an optical fiber preform which has no defects such as shearing and stripping between the core and the cladding region. The above object can be achieved by providing the manufacturing method for optical fiber preform, involving depositing glass particles in the radial direction on an outer peripheral portion of a cylindrical starting material provided with glass material which forms a core, thereby forming a porous layer to form an optical fiber precursor porous material, and sintering the porous material to manufacture an optical fiber preform, wherein a heating step for heating the surface of the starting material is provided adjacently before a step for forming the porous layer.

### BACKGROUND OF THE INVENTION

1. Field of the Invention

The present invention relates to a manufacturing method for optical fiber preform to be used in the production of optical fibers.

2. Description of the Related Art

As a manufacturing method for optical fibers, there is a method which involves forming a porous material suitable for use in optical fibers (hereunder referred to as an optical fiber precursor porous material), and after sintering this optical fiber precursor porous material to give an optical fiber preform, fusing and drawing the preform to obtain an optical fiber.

Also, as manufacturing methods for the optical fiber preform, there is the VAD method, the OVD method, the MCVD method, and the PCVD method. Of these, the OVD (Outside Vapor Phase Deposition) method is a method which involves spraying source material gases such as silicon tetrachloride (SiCl₄) and germanium tetrachloride (GeCl₄), together with oxygen and hydrogen onto a surface of a cylindrical starting material provided with glass material as a core, and heating the surface of the starting material which is rotated about its axis, by an oxy-hydrogen burner, so that glass particles (soot) are deposited to form a porous layer composed of a plurality of layers as the optical fiber precursor porous material, thereby forming the optical fiber perform as a result of transparent vitrification while being dehydrated and sintered in an electric furnace.

However, in the optical fiber preform obtained by sintering the optical fiber precursor porous material, manufacturing defects such as shearing and stripping occur between the core and a cladding region formed by sintering the porous layer. This is thought to be caused by a low degree of adhesion between the starting material and the porous layer, and between the glass particles which form the porous layer, and by great shrinkage of the volume of the porous layer when the optical fiber precursor porous material is sintered. In this way, a low degree of adhesion between the starting material and the porous layer, and between the glass particles which form the porous layer, causes low bulk density in the porous layer.

### SUMMARY OF THE INVENTION

In view of the situation outlined above, the present invention is to provide a manufacturing method for optical fiber preform in which there is no occurrence of manufacturing defects such as shearing and stripping between the core and the cladding region in the optical fiber preform obtained by sintering the optical fiber precursor porous material.

Specifically, an object of the present invention is to provide the manufacturing method for optical fiber preform which raises the bulk density of the porous layer of the optical fiber precursor porous material and improves the degree of adhesion between the starting material and the porous layer, and between the glass particles which form the porous layer.

The above object can be achieved by providing the manufacturing method for optical fiber preform, involving depositing glass particles in the radial direction on an outer peripheral portion of a cylindrical starting material provided with glass material which forms a core, thereby forming a porous layer to form an optical fiber precursor porous material, and sintering the porous material to manufacture an optical fiber preform, wherein a heating step for heating the surface of the starting material is provided adjacently before a step for forming the porous layer.

In the above heating step, the surface of the starting material may be heated to a surface temperature of 600° C. or more, and in said step for forming the porous layer, the surface temperature of the porous layer when depositing the glass particles may be 800 to 150° C.

### BRIEF DESCRIPTION OF THE DRAWINGS

FIG. 1 is a schematic block diagram showing an embodiment of a manufacturing method for optical fiber preform according to the present invention.

### DETAILED DESCRIPTION OF THE INVENTION

Hereunder is a detailed description of the present invention.

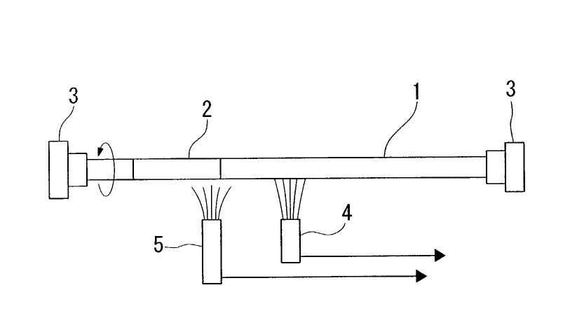

FIG. 1 is a schematic block diagram showing an embodiment of a manufacturing method for optical fiber preform according to the present invention.

In this embodiment of the manufacturing method for optical fiber preform, firstly, a starting material 1 provided at a central section thereof with a glass material made of silica glass to which is added germanium dioxide constituting a core of the optical fiber preform, and having a cylindrical shape of approximately 10 to 40 mm outer diameter and approximately 500 to 2000 mm in length, is prepared. On the outer periphery of this glass material, the silica glass constituting one part of the cladding region of the optical fiber preform may be laminated.

Next, both ends of the starting material 1 are clamped in holding devices 3, and the starting material 1 is positioned horizontally.

Subsequently, the starting material 1 is rotated in this condition about the central axis thereof. Then, the portion to be formed into a porous layer 2 on the surface of the starting material 1 is preheated with a heating burner 4, adjacently before forming the porous layer 2. At this time, the heating burner 4 is moved parallel to a longitudinal direction of the starting material 1. Moreover, an oxy-hydrogen burner or the like is used for the heating burner 4.

After this, source material gases such as SiCl₄ and GeCl₄ are supplied together with oxygen and hydrogen, into an oxy-hydrogen flame of an oxy-hydrogen burner 5, and the glass particles are synthesized by a hydrolysis reaction (a flame hydrolysis reaction) within the flame. These glass particles are deposited in a plurality of layers in the radial direction in a semi-sintered condition on the surface of the starting material 1 which has been heated by the heating burner 4, forming the porous layer 2, to thus obtain an optical fiber precursor porous material.

Next, surplus parts of the obtained optical fiber precursor porous material are removed, and the optical fiber precursor porous material is placed in an electric furnace. Then while being dehydrated in an atmosphere of inert gases such as helium (He) and neon (Ne), this is sintered until it transparently vitrifies, thus obtaining the cylindrical optical fiber preform with an outer diameter of approximately 50 to 200 mm and a length of approximately 300 to 2000 mm.

In the above manufacturing method for optical fiber preform, preferably that the temperature of the part of the surface of the starting material 1 in which the porous layer 2 is formed is heated by the heating burner 4 adjacently before forming the porous layer 2. In this case, the surface of the starting material 1 is preferable preheated to 600° C. or higher, and more preferably 650° C. or higher. When the surface temperature of the starting material 1 is lower than 600° C., then even if the temperature for forming the porous layer 2 is set to a predetermined temperature, the degree of adhesion between the starting material 1 and the porous layer 2, and between the glass particles which form the porous layer 2, are reduced.

The glass particles which form the porous layer 2 are in a semi-molten state when deposited on the surface of the starting material 1. Consequently, by making the surface temperature of the starting material 1 within the above temperature range, the surface of the starting material 1 also becomes the semi-molten state, so that the starting material 1 and the glass particles fuse together, and their degree of adhesion is improved. Also, by making the surface temperature of the starting material 1 within the above temperature range, the glass particles on the surface of the starting material 1 are difficult to cool, and the glass particles are fused together in the semi-molten state, and the degree of adhesion between the glass particles is improved.

In particular, since the surface temperature of the starting material 1 on which the porous layer 2 has not completely formed is extremely low, the surface temperature of the starting material 1 must be made to be within the above temperature range before the porous layer 2 is formed.

In this embodiment of the manufacturing method for optical fiber preform, in order to heat the surface temperature of the starting material 1 to the predetermined temperature, the surface of starting material 1 is heated with the heating burner 4. However, in the manufacturing method for optical fiber preform of the present invention, the entire starting material 1 may be heated by a heat source such as an electric furnace or a plasma torch.

Also, in the above manufacturing method for optical fiber preform, when forming the porous layer 2, the surface temperature of the porous layer 2 is preferably made 800 to 1150° C., and more preferably 900° C. to 1150° C. If done in this way, the degree of adhesion between the starting material 1 and the porous layer 2, and between the glass particles which form the porous layer 2 can be improved. This is because, to improve the degree of adhesion between the starting material 1 and the porous layer 2, and between the glass particles which form the porous layer 2, it is better to raise the formation temperature of the porous layer 2, and increase the bulk density of the porous layer 2. If the formation temperature of the porous layer 2 is high, the glass particles and the starting material 1, and the glass particles themselves fuse together, and their connecting surfaces become larger, and spaces formed therebetween become very small. Consequently, the proportion occupied by the spaces which constitute the porous layer 2 per unit volume of the porous layer 2 becomes smaller, and the bulk density of the porous layer 2 thus increases. To raise the temperature for forming the porous layer 2, and make surface temperature thereof within the above temperature range, the amount of oxygen and hydrogen supplied in the oxy-hydrogen flame of the oxy-hydrogen burner 5 is increased.

Also, when forming the porous layer 2, if the surface temperature of the porous layer 2 is less than 800° C., the bulk density of the porous layer 2 does not increase, and the degree of adhesion between the starting material 1 and the porous layer 2, and between the glass particles which form the porous layer 2, do not improve. On the other hand, if the surface temperature of the porous layer 2 exceeds 1150° C., the condition of the surface of the optical fiber preform obtained bysintering the optical fiber precursor porous material deteriorates. In particular, with the surface temperature of the porous layer 2 above 1200° C., bubbles occur in the optical fiber preform obtained by sintering the optical fiber precursor porous material.

According to the manufacturing method for optical fiber preform of the present invention, the bulk density of the porous layer of the optical fiber precursor porous material can be increased, and the degree of adhesion between the starting material and the porous layer, and between the minute glass particles which form the porous layer, can be improved. Consequently, there is no occurrence of manufacturing defects such as shearing and stripping between the core and the cladding region in the optical fiber preform, obtained by dehydrating and sintering the optical fiber precursor porous material. Also, there are no bubbles created within the obtained optical fiber preform, and hence a stable and homogeneous optical fiber preform can be obtained.

### EXAMPLE

The following shows specific examples using FIG. 1, to clarify the results of the present invention.

First, a cylindrical starting material 1 made from silica glass with an outer diameter of 20 mm and a length of 1000 mm was prepared. Next, both ends of this starting material 1 were clamped in holding devices 3, and the starting material 1 was positioned horizontally. Next, while rotating the starting material 1 about a central axis thereof, glass particles were synthesized by supplying source material gases such as SiCl₄ and GeCl₄, together with oxygen and hydrogen, into an oxy-hydrogen flame of the oxy-hydrogen burner 5. While moving the oxy-hydrogen burner 5 parallel to a longitudinal direction of the starting material 1, glass particles were deposited in the radial direction of the rotating starting material 1 to form the porous layer 2, and a cylindrical optical fiber precursor porous material with an outer diameter of 120 mm and a length of 1000 mm was thus obtained.

At this time, adjacently before forming the porous layer 2, the part of the surface of the starting material 1 in which the porous layer 2 is formed was heated with the heating burner 4, to bring the surface temperature of the starting material 1 to 600° C., and when the porous layer 2 was forming, the surface temperature of the porous layer 2 was brought to 1050° C.

Next, the optical fiber precursor porous material obtained in this way was placed in an electric furnace, and while being dehydrated in an environment of inert gases, was sintered until it transparently vitrified, and a cylindrical optical fiber preform with an outer diameter of 65 mm and a length of 1000 mm was thus obtained.

### Comparative Example 1

A cylindrical optical fiber preform with an outer diameter of 65 mm and a length of 1000 mm was obtained in the same way as for the above example, with the only difference being that adjacently before forming the porous layer 2, the surface temperature of the starting material 1 was brought to 620° C. by heating the part of the surface of the starting material 1 in which the porous layer 2 is formed, with the heating burner 4, and when the porous layer 2 was forming, the surface temperature of the porous layer 2 was brought to 750° C.

### Comparative Example 2

A cylindrical optical fiber preform with an outer diameter of 65 mm and a length of 1000 mm was obtained in the same way as for the above example, with the only difference being that adjacently before forming the porous layer 2, the surface temperature of the starting material 1 was brought to 560° C. by heating the part of the surface of the starting material 1 in which the porous layer 2 is formed, with the heating burner 4, and when the porous layer 2 was forming, the surface temperature of the porous layer 2 was brought to 750° C.

### Comparative Example 3

A cylindrical optical fiber preform with an outer diameter of 65 mm and a length of 1000 mm was obtained in the same way as for the above example, with the only difference being that adjacently before forming the porous layer 2, the surface temperature of the starting material 1 was brought to 560° C. by heating the part of the surface of the starting material 1 in which the porous layer 2 is formed, with the heating burner 4, and when the porous layer 2 was forming, the surface temperature of the porous layer 2 was brought to 1060° C.

The presence or absence of shearing and stripping between the core and the cladding section was confirmed by visual observation, for each of 20 optical fiber preforms obtained from the above example and comparative examples 1 to 3. Results of the above observation are shown in the following Table 1.

TABLE 1

| | Surface temperature | Surface | Proportion of |
|---|---|---|---|
| | of starting material | temperature | stripping and |
| | adjacently before | of porous layer | shearing between |
| | porous layer | when forming | core and cladding |
| | formation (° C.) | porous layer (° C.) | region (%) |
| Example | 650 | 1050 | 0 |
| Compara- | 620 | 750 | 30 |
| tive | | | |
| Example 1 | | | |
| Compara- | 560 | 750 | 50 |
| tive | | | |
| Example 2 | | | |
| Compara- | 560 | 1060 | 35 |
| tive | | | |
| Example 3 | | | |

From the results of Table 1, it could be confirmed that, when the surface of the starting material 1 is heated to give a surface temperature of 650° C., and in the step of forming the porous layer 2, the surface temperature of the porous layer 2 when the glass particles are deposited is 1050° C., there is no stripping and shearing between the core and the cladding region of the obtained optical fiber preform.

As described above, according to the manufacturing method for optical fiber preform of the present invention, the bulk density of the porous layer of the optical fiber precursor porous material can be increased and the degree of adhesion between the starting material and the porous layer, and between the glass particles which form the porous layer, can be improved. Consequently, there is no occurrence of manufacturing defects such as shearing and stripping between the core and the cladding region in the optical fiber preform obtained by dehydrating and sintering the optical fiber precursor porous material. Also, there are no bubbles created within the obtained optical fiber preform, and a stable and homogeneous optical fiber preform can be obtained.

What is claimed is:

1. A manufacturing method for an optical fiber preform, involving depositing glass particles in the radial direction on an outer peripheral portion of a cylindrical starting material provided with glass material which forms a core, thereby forming a porous layer to form an optical fiber precursor porous material, and sintering said porous material to manufacture said optical fiber preform,
wherein a heating step for heating a surface of said starting material is provided adjacently before a step for forming said porous layer.

2. A manufacturing method for an optical fiber preform according to claim 1, wherein the surface of said starting material is heated to 600° C. or more in said heating step for heating the surface of said starting material, and the surface of said porous layer when depositing said glass particles is 800 to 1150° C. in said step for forming said porous layer.
